(19) United States
(12) Patent Application Publication
(10) Pub. No.: US 2024/0082888 A1
(43) Pub. Date: Mar. 14, 2024

(54) MECHANICAL SEAL ASSEMBLY, AND METHOD FOR CLEANING A MECHANICAL SEAL ASSEMBLY

(71) Applicant: EagleBurgmann Germany GmbH & Co. KG, Wolfratshausen (DE)

(72) Inventor: John Merrill, Matthews, NC (US)

(73) Assignee: EagleBurgmann Germany GmbH & Co. KG, Wolfratshausen (DE)

(21) Appl. No.: 18/367,081

(22) Filed: Sep. 12, 2023

(30) Foreign Application Priority Data
Sep. 12, 2022 (DE) 102022123163.1

(51) Int. Cl. B08B 7/02; F16J 15/34

(52) U.S. Cl. CPC B08B 7/028; F16J 15/3404

(57) ABSTRACT

The invention relates to a liquid-lubricated mechanical seal assembly comprising a mechanical seal (2) having a rotating slide ring (3) and a stationary slide ring (4), wherein a sealing gap (5) is defined between a sliding surface of the rotating slide ring (3) and a sliding surface of the stationary slide ring (4), and an ultrasound arrangement (6) having an ultrasound generator (60) and at least one ultrasound head (61), wherein the ultrasound arrangement (6) is configured to direct ultrasonic waves (62) for cleaning onto components of the mechanical seal assembly (1), in order to remove dirt (7) which adheres to the components of the mechanical seal assembly.

The present invention relates to a liquid-lubricated mechanical seal assembly comprising a cleaning device based on ultrasound, and to a method for cleaning the mechanical seal assembly.

Mechanical seal assemblies are known in various embodiments from the prior art. A problem area in the case of mechanical seal assemblies is the contamination, which can occur for example due to wear or due to particles from the medium to be sealed, or the like, and can be deposited on components of the mechanical seal assembly. This can go so far as to impair the functionality of the mechanical seal assembly, both in terms of rotation and also axially, if for example the mechanical seal assembly comprises a bellows, the pleats of which are clogged with dirt, as a result of which the axial mobility of the mechanical seal assembly can be greatly limited. In order to solve this problem, hitherto the mechanical seals are dismantled, and the components thereof cleaned separately. In this case, DE 201 199 13 U1 proposes cleaning the dismantled mechanical seal in such a way that initially pre-cleaning is carried out by means of jet rinsing, and subsequently accurate cleaning is carried out by means of ultrasound. However, such processes lead to downtime of the machine on which the mechanical seal assembly provides sealing, with corresponding downtime costs for the operator.

The object of the present invention is therefore that of providing a mechanical seal assembly and a method for cleaning a mechanical seal assembly, which allows quick and reliable cleaning, with a simple structure and simple, cost-effective implementability, in order to significantly reduce the likelihood of failure of the mechanical seal assembly.

This object is achieved by a mechanical seal assembly having the features of claim 1, and a method having the features of claim 8. The dependent claims each specify preferred developments of the invention.

The liquid-lubricated mechanical seal assembly according to the invention, having the features of claim 1, has the advantage that cleaning in the installed state of the mechanical seal assembly is possible. In particular, cleaning of components of the mechanical seal assembly during ongoing operation of the mechanical seal assembly is also possible. As a result, downtimes of a machine, in which the mechanical seal assembly provides sealing, are omitted. In this case, all the components of the mechanical seal assembly can be cleaned during operation. For this purpose, the liquid-lubricated mechanical seal assembly according to the invention comprises a mechanical seal having a rotating slide ring and a stationary slide ring, which define a sealing gap between the sliding surfaces thereof. Furthermore, the mechanical seal assembly comprises an ultrasound arrangement having an ultrasound generator and at least one ultrasound head, from which the ultrasonic waves are directed onto the components of the mechanical seal assembly to be cleaned. As a result, dirt and particles which adhere on or to the components of the mechanical seal assembly or collect in pockets or undercuts or the like, can be reliably detached and transported away by means of ultrasonic waves. As a result, a possible maximum service life of the mechanical seal assembly is not limited by dirty components. In this case, cleaning of the components of the mechanical seal assembly can be carried out during ongoing operation of the mechanical seal assembly. Components of the mechanical seal assembly therefore do not have to be dismantled. Cleaning furthermore takes place exclusively by means of the ultrasound arrangement integrated into the mechanical seal assembly.

The ultrasound arrangement preferably comprises a plurality of ultrasound heads, which are directed onto the mechanical seal and the components thereof. Preferably, in this case, a plurality of ultrasound heads is arranged along a periphery of the mechanical seal assembly. This ensures that all possibly adhering dirt or particles can be reliably removed from the mechanical seal assembly.

Particularly preferably, the ultrasound heads are arranged adjacently to secondary seals and/or bellows and/or regions on the surfaces of the component of the mechanical seal assembly directed towards the product to be sealed, which regions cannot be rinsed through or can be rinsed through only with difficulty, e.g. an undercut.

Further preferably, the mechanical seal assembly comprises a control unit which is configured to carry out the ultrasonic cleaning in predetermined time intervals. The cleaning therefore does not have to take place continuously, but rather can take place for example once a day or once a week. More preferably, in this case the control unit specifies a temporal length of the cleaning.

According to a further preferred embodiment of the invention, the mechanical seal assembly further comprises at least one rotational speed sensor for detecting rotations of the rotating slide ring or a rotating component on which the rotating slide ring is arranged. In this case, the control unit is preferably configured to carry out ultrasonic cleaning after a predetermined number of rotations.

Preferably, the ultrasound generator is configured to generate ultrasonic waves of different wavelengths. Particularly preferably, cleaning is carried out in this case using ultrasonic waves of different wave lengths. Further preferably, the ultrasound generator is configured to execute an ultrasound peak, i.e. an ultrasonic wave having the greatest possible amplitude, at the start of a cleaning cycle. This makes it possible for settled dirt to be able to be reliably detached from the component, and then comminuted by further ultrasonic waves, and then discharged through the flow of the product to be sealed.

Furthermore, the present invention relates to a method for cleaning a liquid-lubricated mechanical seal assembly in the installed state, comprising the steps of:
generating ultrasonic waves which are directed onto components of the mechanical seal assembly by means of an ultrasound arrangement having an ultrasound generator and an ultrasound head, wherein the ultrasound arrangement is integrated into the mechanical seal assembly.

Further preferably, the ultrasonic cleaning is carried out during operation of the mechanical seal. Thus, the mechanical seal and further components of the mechanical seal assembly no longer has to be dismantled for cleaning and cleaned externally in the prior art, but rather the cleaning can take place in the mounted state of the mechanical seal assembly. In this case, the machine on which the sealing takes place does not have to be stationary, but rather can continue to be operated.

Further preferably, the ultrasonic cleaning is carried out in predetermined time intervals and/or the ultrasonic cleaning is carried out depending on a number of performed rotations of the components of the mechanical seal assembly. The control unit is configured for example to carry out the cleaning either depending on the performed rotations of the rotating components of the mechanical seal, or, if the number of performed rotations does not reach a specified target value, to clean in predetermined time intervals.

Further preferably, the ultrasound generation assembly is configured to generate an ultrasound peak, at the start of a cleaning cycle for detaching dirt and/or particles, which ultrasound peak detaches dirt and the like. Subsequently, normal ultrasonic cleaning can be carried out.

In the following, a preferred embodiment of the invention will be described in detail, with reference to the accompanying drawings. In the drawings:

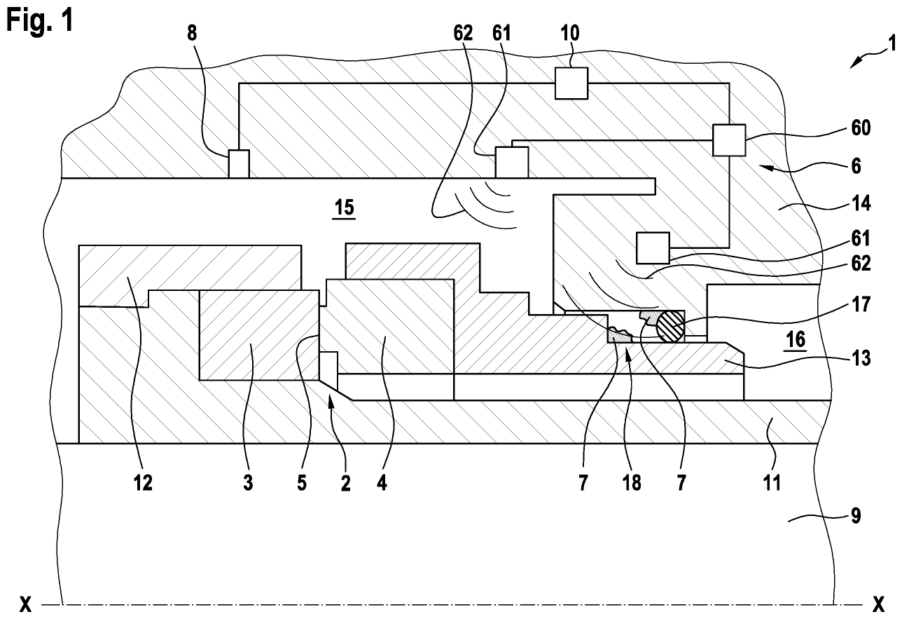

FIG. 1 is a schematic sectional view of a mechanical seal assembly according to a preferred embodiment of the invention,

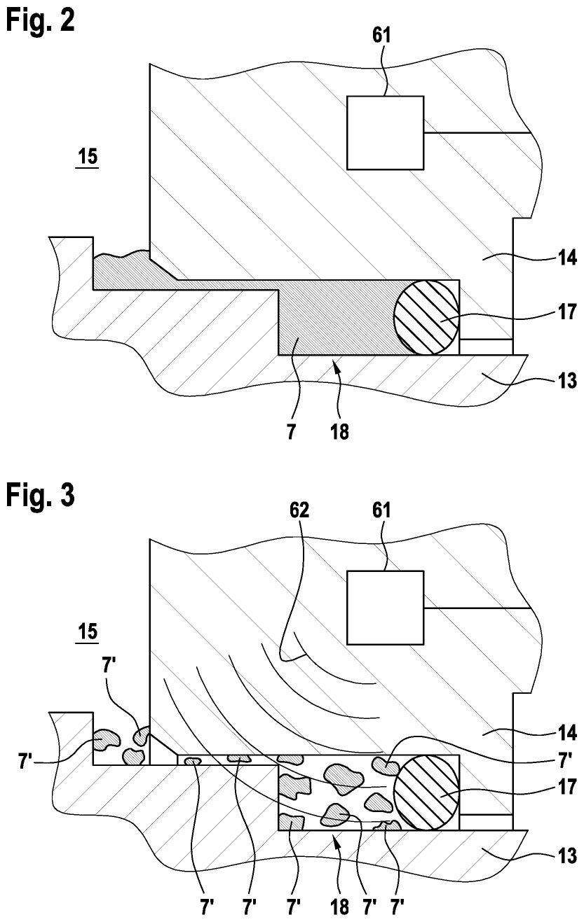

FIG. 2 is a schematic sectional view of a contaminated region of the mechanical seal assembly from FIG. 1, and

FIG. 3 is a schematic sectional view corresponding to FIG. 2, in which the contamination is detached by means of ultrasonic waves.

In the following, a liquid-lubricated mechanical seal assembly 1 and a method for cleaning the mechanical seal assembly 1 are described in detail, with reference to FIGS. 1 to 3.

As is clear from FIG. 1, the liquid-lubricated mechanical seal assembly 1 comprises a mechanical seal 2 having a rotating slide ring 3 and a stationary slide ring 4. A sealing gap 5 is defined between a sliding surface of the rotating slide ring 3 and a sliding surface of the stationary slide ring 4.

The mechanical seal assembly 1 seals a product region 15 from an atmosphere region 16. In this case, the mechanical seal assembly 1 is arranged on a shaft 9 on a rotating sleeve 11.

The rotating slide ring 3 is fixed on the rotating sleeve 11 by means of a carrier element 12 and rotates together with the rotating sleeve 11 and together with the shaft 9.

The shaft 9 comprises a central axis X-X.

The stationary slide ring 4 is held on a housing 14 in a non-rotatable manner by means of a stationary sleeve 13. In this case, a secondary seal 17 (O-ring) ensures that no product from the product region 15 enters the atmosphere region 16 via a gap between the stationary sleeve 13 and the housing 14.

Dirt 7 or particles or similar can collect in an undercut 18 and adhere to the components, in the product region 15 in front of the secondary seal 17. This region on the secondary seal 17 is not, or only poorly, rinsed through during operation of the mechanical seal assembly. There is therefore the risk, here, that particles, dirt or the like, which can result due to wear of components, or also may originate from contamination in the product to be sealed, may significantly impair the functioning of the mechanical seal assembly, in particular with respect to its repositioning.

The mechanical seal assembly 1 further comprises an ultrasound arrangement 6 which is connected to a control unit 10. The ultrasound arrangement 6 comprises an ultrasound generator 60 and two ultrasound heads 61. Ultrasonic waves 62 are emitted by the ultrasound heads 61.

As is clear from FIGS. 1 and 3, in this case the ultrasonic waves 62 are directed onto the component of the mechanical seal 2. The adhering dirt 7 is detached by the soundwaves, which is indicated schematically in FIG. 3. In this case, the detached dirt particles are denoted by reference sign 7′.

The mechanical seal assembly 1 further comprises a rotational speed sensor 8, which is also connected to the control unit 10.

In this case, the control unit 10 controls the ultrasound arrangement 6 to generate ultrasonic waves 62. A significant advantage of the invention is that the cleaning of components of the mechanical seal assembly can be carried out during operation of the mechanical seal assembly, i.e. when the shaft 9 rotates, and thus also the rotating slip ring 3 rotates.

Since the dirt particles accumulate, over time, on certain components of the mechanical seal assembly 1 and may get stuck there, the control unit 10 is configured to carry out the ultrasonic cleaning by means of the ultrasound arrangement 6 in predetermined time intervals. This may be for example once a day or once a week or once a month.

Furthermore, the control unit 10 is configured, by means of the rotational speed sensor 8 or alternatively also from other sources, which can originate for example from the controller of the machine to be sealed, to carry out the cleaning depending on performed rotations of the mechanical seal 2, if a predetermined target value for the number of rotations is exceeded.

It is possible here, for example, for the control unit to carry out cleaning always after a predetermined achieved number of performed rotations of the mechanical seal 2. If this number is achieved still within the normally provided cleaning interval (for example one month), cleaning of the components by means of ultrasound thus already takes place before the actually predetermined time interval.

The time intervals for cleaning are selected depending on the contamination level, for example contamination of the product to be sealed.

Furthermore, the ultrasound generator 60 is configured to generate ultrasonic waves having different amplitudes. In this case, the control unit is configured to generate an ultrasound peak, preferably at the start of a cleaning cycle for detaching the dirt 7, in order to allow for detachment of the dirt from the components of the mechanical seal assembly.

Thus, the mechanical seal 2 does not have to be dismantled for cleaning and removing adhering dirt 7, but rather can be cleaned in the mounted state. In this case, cleaning during ongoing operation of the mechanical seal assembly 1, i.e. when the slip ring 3 is rotating, is possible. Alternatively, the machine can also be stopped, and cleaning of components of the mechanical seal assembly 1 can then take place, without dismantling, by means of ultrasonic waves 62. The cleaning can take place exclusively by means of ultrasound. Thus, the present invention offers significant advantages for a machine operator, since the machine does not actually have to be stopped in order for the mechanical seal assembly 1 to be cleaned.

### LIST OF REFERENCE CHARACTERS

1 mechanical seal assembly
2 mechanical seal
3 rotating slide ring
4 stationary slide ring
5 sealing gap
6 ultrasound arrangement
7 dirt
7′ detached dirt/detached dirt particles
8 rotational speed sensor
9 shaft
10 control unit
11 rotating sleeve
12 carrier
13 stationary sleeve
14 housing
15 product region
16 atmosphere region
17 secondary seal
18 undercut
60 ultrasound generator
61 ultrasound head
62 ultrasonic wave
X-X central axis of the shaft

1. Liquid-lubricated mechanical seal assembly, comprising:
a mechanical seal having a rotating slide ring and a stationary slide ring, wherein a sealing gap is defined between a sliding surface of the rotating slide ring and a sliding surface of the stationary slide ring, and
an ultrasound arrangement having an ultrasound generator and at least one ultrasound head,
wherein the ultrasound arrangement is configured to direct ultrasonic waves for cleaning onto components of the mechanical seal assembly, in order to remove dirt which adheres to the components of the mechanical seal assembly.

2. Mechanical seal assembly according to claim 1, comprising a plurality of ultrasound heads which are directed onto components of the mechanical seal assembly.

3. Mechanical seal assembly according to claim 1, wherein the ultrasound head is arranged adjacently to a secondary seal and/or a bellows of the mechanical seal.

4. Mechanical seal assembly according to claim 1, further comprising a control unit which is configured to carry out the ultrasonic cleaning in predetermined time intervals.

5. Mechanical seal assembly according to claim 1, further comprising a rotational speed sensor for detecting rotations of the rotating slide ring of the mechanical seal, wherein the control unit is configured to carry out the ultrasonic cleaning after a predetermined number of rotations.

6. Mechanical seal assembly according to claim 1, wherein the ultrasound arrangement is configured to generate ultrasonic waves having different amplitudes.

7. Mechanical seal assembly according to claim 6, wherein the control unit is configured to generate an ultrasound peak at the start of a cleaning cycle.

8. Method for cleaning a liquid-lubricated mechanical seal assembly in the installed state of the mechanical seal assembly, comprising the steps of:
generating ultrasonic waves by means of an ultrasound generator and at least one ultrasound head, wherein the ultrasonic waves are directed onto components of the mechanical seal assembly, wherein the ultrasound arrangement is integrated into the mechanical seal assembly.

9. Method according to claim 8, wherein the ultrasonic cleaning is carried out by means of the ultrasound arrangement during operation of the mechanical seal assembly.

10. Method according to either claim 8, wherein the ultrasonic cleaning is carried out in predetermined time intervals.

11. Method according to claim 8, wherein the ultrasonic cleaning is carried out depending on a number of rotations of the mechanical seal assembly performed.

12. Method according to claim 8, wherein the ultrasound arrangement generates an ultrasound peak at the start of a cleaning cycle for detaching dirt.
